(19) United States
(12) Patent Application Publication
(10) Pub. No.: US 2020/0376729 A1
(43) Pub. Date: Dec. 3, 2020

(54) TECHNIQUES FOR OVERMOLDING THERMOPLASTICS ONTO A SPRAY PRIMED POLYMER SUBSTRATE

(71) Applicant: MICROSOFT TECHNOLOGY LICENSING, LLC, Redmond, WA (US)

(72) Inventors: Tao WANG, Zhengzhou City (CN); Brian J. TOLENO, Cupertino, CA (US); Simon HODGSON, Morgan Hill, CA (US); Beng Teong LOH, Suzhou (CN)

(21) Appl. No.: 16/427,890

(22) Filed: May 31, 2019

(51) Int. Cl. B29C 45/14; B32B 3/26; B32B 27/36

(52) U.S. Cl. CPC B29C 45/14311; B32B 3/266; B29K 2069/00; B32B 2260/046; B32B 2255/10; B32B 27/365

(57) ABSTRACT

Techniques for overmolding thermoplastics onto a spray primed polymer substrate. A thin layer of primer may be sprayed directly over a pre-formed polymer material. Then, a thermoplastic is injection molded directly over the primer layer. In one embodiment, a carbon fiber-reinforced polymer (CFRP) fabric is thermal compression molded into a NED device housing shell. Selected portions of the NED device housing shell may be mechanically abraded and then sprayed with a solvent-based polyolefin primer. Once the primer layer has cured, a thermoplastic material may then be overmolded directly over the primer layer—without any additional adhesive layer(s) between the primer layer and the thermoplastic material.

### BACKGROUND

Overmolding is a process for seamlessly joining two or more different types of materials into a single part. Typically, a first material such as a thermoplastic or a thermoplastic elastomer is injection molded directly over a second material such as a metal or another thermoplastic. The second material is pre-manufactured into a desired shape via machining and/or molding processes prior to being inserted into a mold cavity that is specifically shaped to form a desired end-shape of the first material. Then, the overmolding process is performed during which the first material is melted and injected into the mold cavity over the second material. The second material serves as a substrate onto which the first material adheres following the overmolding process. Since the goal of overmolding is to create single parts by seamlessly joining different materials, adhesion between the “substrate” material and “overmolded” material is an important consideration in designing overmolding processes.

Depending on material selection, a bare surface of the substrate material may lack suitable properties for the overmolded material to adhere to. For this reason, some overmolding processes include applying a suitable combination of a primer layer and an adhesive layer to the substrate material. Then, the overmolded material is molded over the adhesive layer that is applied to the substrate material. Unfortunately, each of the primer layer and the adhesive layer must be applied independently and allowed to cure before the process can continue—each step increasing manufacturing time. Furthermore, the adhesive layer is typically highly viscous and suitable for brush application only. This results in a high degree of part-to-part variability since the manual process of brushing on a viscous adhesive can be loosely controlled at best.

It is with respect to these considerations and others that the disclosure made herein is presented.

### SUMMARY

Technologies described herein provide techniques for overmolding thermoplastics onto a spray primed polymer substrate. Generally described, the techniques disclosed herein include spraying a thin layer of primer directly over a pre-formed polymer material and then overmolding a thermoplastic directly over the primer layer. For example, a suitable polymer material such as a carbon fiber-reinforced polymer (CFRP) fabric may be thermal compression molded into a pre-formed substrate of a desired shape. In some implementations, selected portions of the pre-formed substrate may be roughened via one or more abrasion processes. Additionally, or alternatively, the selected portions of the pre-formed substrate may be machined to achieve tight geometrical tolerances prior to the upcoming overmolding process. In order to prepare the pre-formed substrate for overmolding, a thin layer of a suitable primer such as, for example, a solvent-based polyolefin primer may be sprayed directly over the selected portions of the pre-formed substrate. Once the primer layer has cured, a thermoplastic material may then be overmolded directly over the primer layer—without any additional adhesive layer(s) between the primer layer and the thermoplastic material.

In this way, the manufacturing time required to make the overmolded part is significantly reduced since the additional step of applying an adhesive layer over the top of the primer layer is eliminated. Furthermore, the part-to-part consistency is improved over conventional techniques that require brushed-on adhesive since the process of spraying on a primer layer is significantly more controllable than the process of brushing on an adhesive layer. This is largely because the viscosity of the primer layer is typically significantly less than the viscosity of the adhesive layer. For example, a solvent-based polyolefin primer may have a viscosity on the order of one-hundred centipoise (CPS) or less whereas a highly cross-linked adhesive may have a viscosity on the order of fifteen-hundred CPS or more.

In an exemplary implementation, the overmolding techniques described herein may be used to manufacture a Near-Eye-Display (NED) device housing having a housing shell with a perimeter portion that is seamlessly joined with an overmolded thermoplastic material to form a smooth and rounded edge. In some embodiments, the housing shell may be formed from a fiber-reinforced polymer. For example, the housing shell may be formed by thermal compression molding a thermosetting epoxy resin impregnated carbon fiber-reinforced polymer (CFRP) fabric into a desired substrate shape. The housing shell that results from this initial molding process may be machined to introduce features (e.g., holes for sensors to mount or protrude) and/or to achieve tighter tolerances than are obtainable via molding alone (e.g., to provide a precise outer profile). Major benefits that a CFRP material may provide for use as the housing shell include being both lightweight and having a suitable rigidity and stiffness. It will be appreciated, however, that the outer perimeter of a CFRP part typically has fibrous strands protruding slightly therefrom. These protrusions may increase the probability of delamination and may also cause injury if grabbed by a user. For this reason, it may be desirable to convert the sharp and fibrous outer perimeter of the CFRP housing shell into a smooth and rounded perimeter via overmolding a thermoplastic material onto the housing shell.

Once the housing shell is pre-formed into the desired substrate shape, selected portions of the housing shell may be mechanically abraded to remove any residual releasing agent and to roughen the surface prior to application the primer solution. For example, housing shell may be placed into a fixture that selectively covers (e.g., masks) portions of the housing shell which are not to be abraded. Then, the exposed (e.g., unmasked) portions of the housing shell may be abrasively blasted with a suitable media (e.g., sand). Following the mechanical abrasion, the housing shell may be cleaned to remove any residual media and/or other contaminants. For example, at least the selected portions of the housing shell may be cleaned with 50:50 mixture of isopropyl alcohol and water. As a result of the mechanical abrading and the subsequent cleaning, the selected portions of the housing shell will be both free from contaminants and also sufficiently rough for the primer layer to strongly adhere to.

Then, as a final step prior to molding the thermoplastic material over the housing shell, a primer solution may be deposited onto the selected portions of the housing shell. As a specific but nonlimiting example, an exemplary primer solution may be a single component solvent-based polyolefin primer. In some implementations, the primer solution may be thinned to a viscosity that is on the order of one-hundred centipoise (CPS) or less. The low viscosity of the primer solution (e.g., as compared to a typical adhesive) enables the primer solution to be deposited both evenly and thinly. In some embodiments, the primer solution is sprayed onto the housing shell via a spray gun such as, for example, a high-volume low-pressure (HVLP) spray gun. In this way, even complex geometrical features of the housing shell (e.g., holes, curved surfaces, and so on) may be evenly coated with an exceedingly thin primer layer in a fast and highly repeatable manner. After being deposited onto the housing shell, the primer layer is then caused to dry or cure as needed to achieve optimal adhesion to the housing shell. For example, where a solvent-based primer is used, the newly deposited primer layer may be allowed to dry via solvent evaporation. In some implementations, the housing shell is controllably heated (e.g., baked) following deposition of the primer layer to increase the drying speed and to improve the resulting adhesion. As a specific but nonlimiting example, the housing shell may be baked at a nominal temperature of 80° Celsius for a nominal period of 20 minutes.

Finally, once the primer layer has cured, a thermoplastic material may be overmolded directly over the primer layer to form the NED device housing having the polymer-based housing shell that is seamlessly joined with an overmolded thermoplastic material. In this way, various features that are not suitable to be formed via thermal compression molding may be added to the polymer-based housing shell—without any additional adhesive layer(s) between the primer layer and the thermoplastic material. Furthermore, in embodiments where the polymer-based housing shell is fiber-reinforced, the “rough” perimeter of the housing shell that would otherwise have fibers protruding therefrom and be susceptible to delamination can be converted to rounded edge that is smooth to the touch and that prevents delamination.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the figures, the left-most digit(s) of a reference number identifies the figure in which the reference number first appears. The same reference numbers in different figures indicates similar or identical items. References made to individual items of a plurality of items can use a reference number followed by a parenthetical containing a number of a sequence of numbers to refer to each individual item. Generic references to the items may use the specific reference number without the sequence of numbers. For example, the items may be collectively referred to with the specific reference number preceding a corresponding parenthetical containing a sequence number.

FIG. 1A is a side view of a conventional “prior art” technique of brushing a viscous adhesive layer over primer layer that is deposited on a polymer substrate in preparation for overmolding of a thermoplastic.

FIG. 1B is a side view of a conventional “prior art” technique of injection molding a thermoplastic over both the primer layer and the brushed-on adhesive layer that is shown in FIG. 1A.

FIG. 1C is a top view of a typical finished part that is obtained from the conventional “prior art” technique of injection molding shown in FIG. 1B.

FIG. 1D is a side view of the typical finished part shown in FIG. 1C.

FIG. 2A is a side view of a technique for spraying on a primer layer directly over a polymer substrate in preparation for overmolding of a thermoplastic.

FIG. 2B is a side view of a technique for injection molding a thermoplastic directly over the primer layer of FIG. 2A—without any additional adhesive layer(s) between the primer layer and the thermoplastic material.

FIG. 2C is a top view of a finished part that is obtained after injection molding the thermoplastic material directly over the primer layer as shown in FIG. 2B.

FIG. 2D is a side view of the finished part shown in FIG. 2C.

FIG. 3 is an exploded view of an uncured polymer sheet disposed between a housing shell mold core and a housing shell mold cavity for forming a Near-Eye-Display (NED) device housing shell that is suitable for overmolding using the techniques described herein.

FIG. 4 illustrates an exemplary primer deposition process being performed on a NED device housing shell that has been formed and machined as described in relation to FIG. 3.

FIG. 5 illustrates is a detailed view of the NED device housing shell with seamlessly integrated with an overmolded thermoplastic structure.

FIG. 6 is a flow chart of an exemplary process for forming a fiber-reinforced polymer housing that is seamlessly joined with a thermoplastic structure that is overmolded directly over a primer layer.

### DETAILED DESCRIPTION

The following Detailed Description describes technologies for molding a thermoplastic material directly onto a layer of primer that has been deposited directly onto a suitable substrate material. That is, the thermoplastic material is adhered to the substrate material via a suitable primer layer without any additional adhesive layers. In various embodiments, a solvent-based primer may be sprayed directly over a pre-formed polymer substrate—which may be mechanically abraded for increased adhesion. As a specific but nonlimiting example, the pre-formed polymer substrate may be made by thermal compression molding a thermosetting epoxy resin impregnated carbon fiber-reinforced (CFRP) fabric into a desired shape. Following the molding process, selected portions of the pre-formed substrate may be abrasively blasted with a suitable media to roughen the selected portions for increased adhesion of a primer layer. Then, the pre-formed polymer substrate may be primed in preparation for overmolding of the thermoplastic material. In various embodiments, the step of priming the pre-formed polymer substrate may include spraying a layer of a polyolefin primer directly over the selected portions using a suitable spray tool. Once the primer layer has cured, a thermoplastic material may then be overmolded directly over the primer layer—without any additional adhesive layer(s) between the primer layer and the thermoplastic material.

The presently disclosed techniques enable overmolded thermoplastic structures to be formed that are significantly thinner and smaller than can be achieve using conventional techniques where both a primer layer and an adhesive layer are deposited between the substrate and the overmolded thermoplastic. As described in detail below, one reason for this is that the adhesives that are used to form the adhesive layers are typically highly viscous and, therefore, need be brushed on in thick (e.g., 1 mm or more) layers. These thick and viscous adhesive layers frequently result in gaps at the interface between the overmolded thermoplastic and the substrate and/or “over glue” sections where excess adhesive bulges out of the interface between the overmolded thermoplastic and the substrate. As described below, the techniques described herein mitigate these issues. Additional benefits of the techniques disclosed herein include reductions in manufacturing time since the additional step of applying an adhesive layer over the top of the primer layer is eliminated. Furthermore, part-to-part consistency is improved over conventional techniques that require brushed-on glue since the process of spraying on a primer layer is significantly more controllable than the process of brushing on an adhesive layer (e.g., due to viscosity of the primer solution being significantly less than the viscosity of the adhesive).

The present invention is believed to be applicable to a variety of circumstances where molding layers of thermoplastic material over a polymer substrate is desired. Aspects of the techniques disclosed below are predominantly described in the context of overmolding a thermoplastic over the perimeter of a CFRP housing shell for a NED device. While the present techniques are not necessarily limited to manufacturing such housing shells for NED devices, an appreciation of various aspects of the techniques is readily gained through a discussion of examples of manufacturing such components. Thus, while the presently disclosed techniques are suitable for manufacturing CFRP housing shells for NED devices, the techniques are also suitable for manufacturing a wide array of other components.

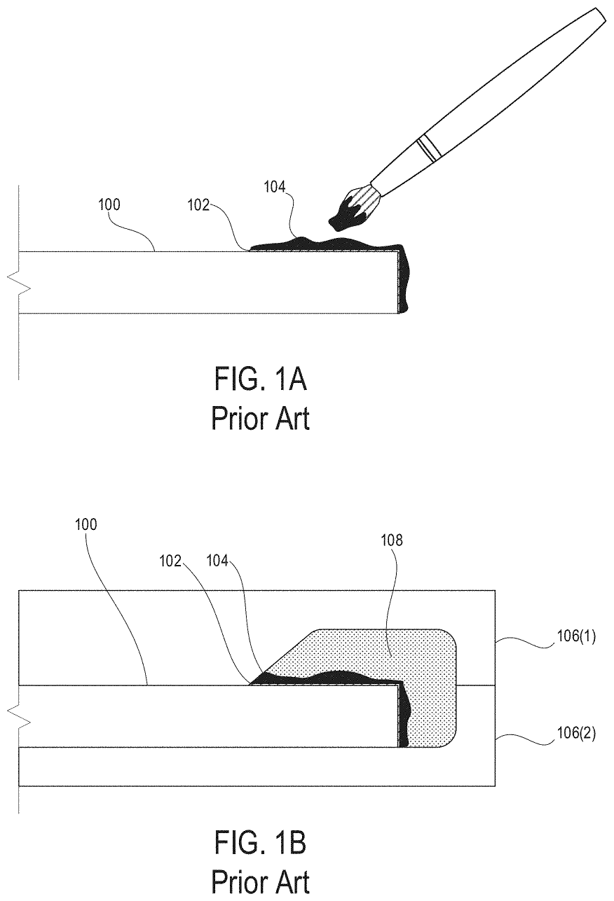

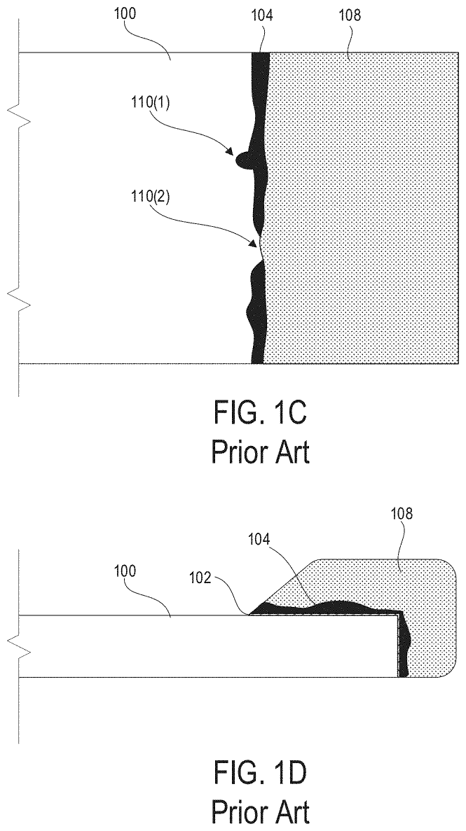

Turning now to FIG. 1A, illustrated is a side view of a conventional “prior art” technique of brushing an adhesive layer 104 over the top of a primer layer 102 that has previously been deposited onto a polymer substrate 100 in preparation for overmolding of a thermoplastic. As illustrated, a thickness of the adhesive layer 104 (shown as solid black) varies across the relevant portion of the polymer substrate 100. It will be appreciated that such variations in thickness are typical in many applications where a viscous substance is applied to a substrate by brush. Adhesives that are commonly available and frequently used for overmolding thermoplastics are typically highly internally cross-linked which results in viscosities of fifteen-hundred centipoise (CPS) or more. Such viscosity levels render these adhesives ill-suited for spray applications and even render brush-on applications quite difficult to control and highly susceptible to variation.

Turning now to FIG. 1B, illustrated is a side view of a conventional “prior art” technique of injection molding a thermoplastic over both the primer layer and the brushed on adhesive layer of FIG. 1A. As illustrated, the polymer substrate 100 with the combined primer layer 102 and adhesive layer 104 is enclosed within a cavity that is formed by bringing two mold components 106 together. More specifically, a first mold component 106(1) and a second mold component 106(2) are pressed together to form the cavity. In the illustrated example, the cavity is formed over only a portion of the polymer substrate 100 where the adhesive layer 104 has been brushed on (e.g., on the right side of the polymer substrate). Then, while the first mold component 106(1) and the second mold component 106(2) are tightly pressed together, a molten thermoplastic 108 is injected into the formed cavity and into direct contact with the adhesive layer 104. Then, the thermoplastic 108 is allowed to cool and harden to form a finished part with an outer profile that is defined by the mold cavity.

Turning now to FIG. 1C, illustrated is a top view of a typical finished part that is obtained from the conventional “prior art” technique of injection molding shown in FIG. 1B. FIG. 1D is a side view of the typical finished part shown in FIG. 1C. As shown in FIG. 1C, some amount of the adhesive layer 104 exists at an interface between the thermoplastic material 108 and the polymer substrate 100. However, the amount of adhesive layer 104 varies across different portions 110 of the interface between the thermoplastic material 108 and the polymer substrate 100. As illustrated, at a first portion 110(1) of the interface a relatively large amount of the adhesive layer 104 is shown to bulge out unevenly from the rest of the adhesive layer 104. This may occur due to the viscous adhesive being inadvertently brushed on too thickly near this first portion 110(1). This may also occur due to the large amounts of pressure and/or heat that the adhesive layer 104 is subjected to while the thermoplastic material 108 is injected into the cavity causing the adhesive to move or flow during the injection molding process. As further illustrated, at a second portion 110(2) of the interface, a gap between the thermoplastic material 108 and the polymer substrate 100 results from a lack of adhesive. This may occur due to a failure of an operator to reach this portion when brushing on the viscous adhesive.

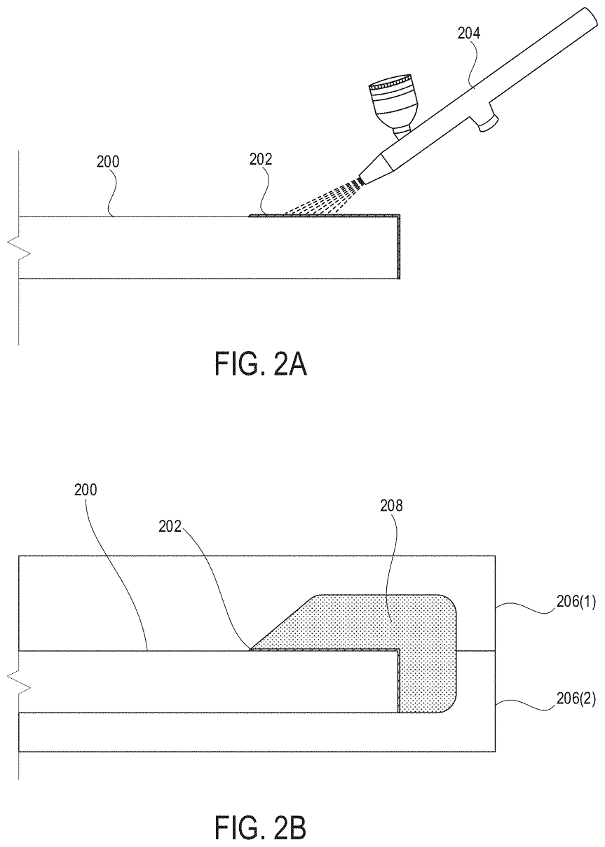

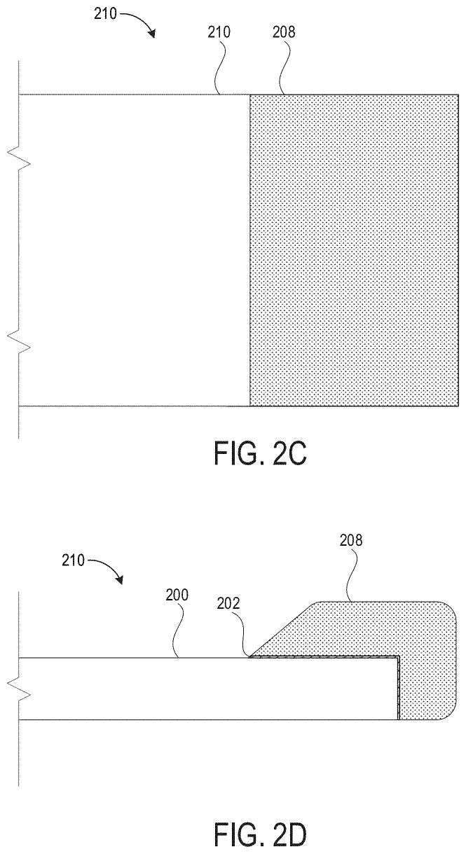

Turning now to FIG. 2A, illustrated is a side view of a technique for spraying on a primer layer 202 directly over a polymer substrate 200 in preparation for overmolding of a thermoplastic. As illustrated, a primer layer 202 is shown being sprayed out of a spray tool 204 onto a desired region of a polymer substrate 200. In some embodiments, the polymer substrate 200 may be a composite material that comprises a polymer base material that is reinforced or impregnated with a fibrous matrix. As a specific but nonlimiting example, the polymer substrate 200 may be a formed by thermal compression molding a carbon fiber-reinforced polymer (CFRP) fabric into a pre-formed substrate of a desired shape. Alternatively, the polymer substrate 200 may be an unfilled and homogenous polymer material.

In some embodiments, the primer layer 202 may be a single component solvent-based polyolefin primer. It will be appreciated that such polyolefin primer solutions are known to be suitable to treat various surfaces to be bonded with various adhesives. For example, a polyolefin primer solution may be used to treat carbon surfaces, metal surfaces, or other low energy surfaces to be bonded with an adhesive layer as described in relation to FIGS. 1A-1D. However, such polyolefin primers have not been previously used to treat selected regions of a polymer substrate (e.g., a CFRP substrate) to provide a direct bonding site for thermoplastic. Rather, such polyolefin primers have been used merely to provide a bonding side for an intermediate adhesive layer onto which a thermoplastic is overmolded—which results in many problems as described in relation to FIGS. 1A-1D.

In some embodiments, the primer layer 202 may be sprayed onto the polymer substrate 200 via a high-volume low-pressure (HVLP) type spray gun. In order to optimize the atomization, the primer solution may be thinned to a viscosity of one-hundred centipoise (CPS) or less by adding a suitable amount of a solvent. The low viscosity of the primer solution (e.g., as compared to a typical adhesive) enables the primer solution to be deposited both evenly and thinly. Moreover, by spraying the primer onto the polymer substrate 200, even complex geometrical features (e.g., holes, bosses, and so on) may be evenly coated with an exceedingly thin primer layer in a fast and highly repeatable manner.

In some implementations, selected portions of the polymer substrate 200 may be roughened via one or more abrasion processes prior to the process of spraying the primer solution onto the selected portions. As a specific example, the polymer substrate 200 may be partially covered so as to selectively mask portions which are not to be abraded. Then, the exposed (e.g., unmasked) portions of the polymer substrate 200 may be abrasively blasted with a suitable media (e.g., sand). The polymer substrate 200 may then be cleaned to remove any residual media and/or other contaminants. For example, the polymer substrate 200 may be wiped off with a cloth that is dampened with a 50:50 mixture of isopropyl alcohol and water. Additionally, or alternatively, the polymer substrate 200 may be blasted with a high-pressure stream of air. This cleaning will result in the polymer substrate 200 being both free from contaminants and also sufficiently rough for the primer layer to strongly adhere to.

Following the step of spraying the primer solution onto the polymer substrate 200, the primer solution is then caused to dry (e.g., via solvent evaporation) so as to form the “dry” primer layer 202. In some implementations, the polymer substrate 200 and recently sprayed “wet” primer is controllably heated (e.g., baked) to increase the drying speed and to improve the resulting adhesion of the resulting “dry” primer layer 202. As a specific but nonlimiting example, the polymer substrate 200 with the recently sprayed “wet” primer may be baked at a temperature of 80° Celsius for at least 20 minutes.

It should be appreciated that the process of spraying on an atomized solution having a viscosity of 100 CPS or less will yield a layer that is significantly thinner than is obtainable via brushing on a viscous gel having a viscosity of 1500 CPS or more. Furthermore, the variation in the resulting layer thickness will be significantly less via the process of spraying on the low viscosity (e.g., 100 CPS or less) primer solution as depicted in FIG. 2A as compared to the process of brushing a high viscosity gel adhesive as depicted in FIG. 1A.

Turning now to FIG. 2B, illustrated is a side view of a technique for injection molding a thermoplastic directly over the primer layer of FIG. 2A. As illustrated, the polymer substrate 200 is inserted into a mold with the primer layer 202 that was deposited and allowed to cure as described in relation to FIG. 2A. More specifically, a first mold component 206(1) and a second mold component 206(2) are pressed together to form a cavity. In the illustrated example, the cavity is formed over only a portion of the polymer substrate 200 where the primer layer 202 has been deposited via the spray tool 204. Then, while the first mold component 206(1) and the second mold component 206(2) are tightly pressed together, a molten thermoplastic 208 is injected into the formed cavity and into direct contact with the primer layer 202—without any additional adhesive layer(s) between the primer layer 202 and the thermoplastic material 208. Then, the thermoplastic 208 is allowed to cool and solidify to form a finished part.

In some embodiments, the thermoplastic 208 is a polycarbonate resin based compound that includes various additives such as, for example, glass fibers, flame retardants, etc.

Turning now to FIG. 2C, illustrated is a top view of a finished part 210 that is obtained after injection molding the thermoplastic material 208 directly over the primer layer 202 as shown in FIG. 2B. FIG. 2D is a side view of the finished part 210 shown in FIG. 2C. As shown in FIG. 2C, the finished part 210 has an interface 212 between the thermoplastic material 208 and the polymer substrate 200 that is highly consistent. Stated alternatively, there is little if any variation at the interface 212. For example, as compared to the interface shown in FIG. 1C, the thermoplastic material 208 being molding directly over the primer layer 202 mitigates the presence of gaps between the thermoplastic material 208 and the polymer substrate 200 and also “over glue” portions where excess adhesive bulges out from the interface.

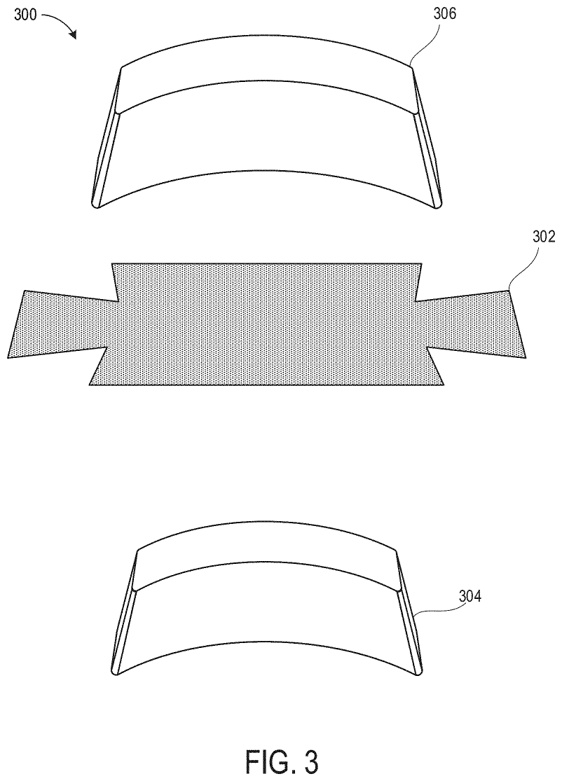

Turning now to FIG. 3, illustrated is an exploded view 300 of an uncured polymer sheet 302 disposed between a housing shell mold core 304 and a housing shell mold cavity 306. The uncured polymer sheet 302 may be formed into a Near-Eye-Display (NED) device housing shell that is suitable for overmolding using the techniques described herein.

In an exemplary embodiment, the uncured polymer sheet 302 may be a carbon fiber-reinforced polymer (CFRP) fabric that is impregnated with or otherwise includes a thermoset polymer resin in an uncured state. In this way, the uncured polymer sheet 302 is highly pliable and can be draped over, wrapped around, or otherwise caused to substantially comply to the outer shape of the housing shell mold core 304.

With the sheets of the uncured polymer sheet 302 formed around the housing shell mold core 304, the housing shell mold cavity 306 and the housing shell mold core 304 may then be pressed together to compress the uncured polymer sheet 302 into the desired shape. It will be appreciated that although the inner portion of the housing shell mold cavity 306 is not shown, the shape of this inner portion will substantially match (but maybe slightly larger than) the outer surface of the housing shell mold core 304. For example, when the housing shell mold cavity 306 and the housing shell mold core 304 are brought together a substantially uniform gap of one to two millimeters may be present there between.

While the uncured polymer sheet 302 is compressed between the housing shell mold cavity 306 and the housing shell mold core 304, heat may be applied to initiate curing of the currently uncured resin of the polymer sheets 302. It will be appreciated that application of heat to the uncured resin may result in various chemical reactions that create extensive cross-linking between polymer chains to produce a rigid NED device housing of the desired shape.

After completion of the thermal compression molding process described in relation to FIG. 3, various features may be precisely machined into the NED device housing shell. For example, one or more through sensor apertures may be machined into the housing shell to provide a view of an external real-world environment to one or more sensors that are to be mounted internal to the NED device housing shell. As a specific but non-limiting example, the NED device housing shell may be affixed to a machine bed of a multi-axis computer numerical control (CNC) machine. Then, the multi-axis CNC machine may be caused to run one or more CNC programs to cut or drill various features (e.g., holes for sensors to mount or protrude) into the NED device housing shell and/or to achieve tighter tolerances for a perimeter than are obtainable via molding alone (e.g., to provide a precise outer profile).

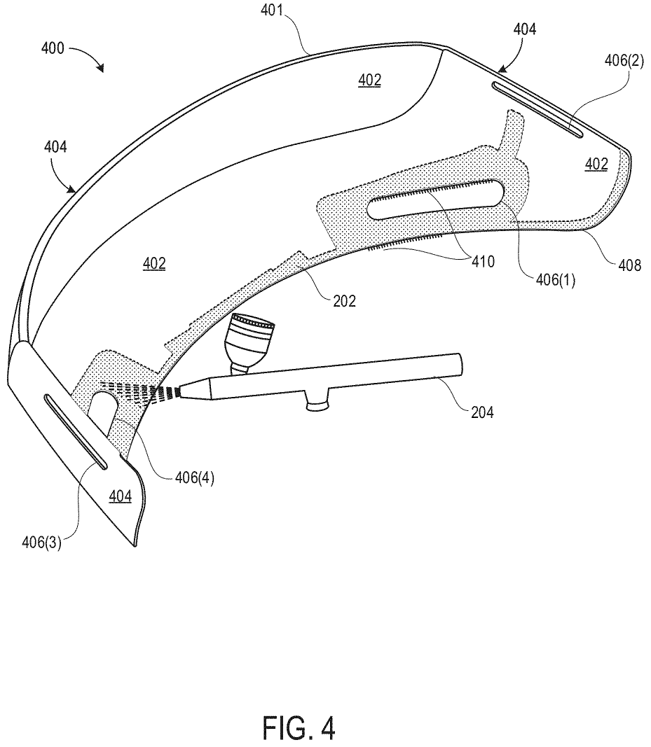

Turning now to FIG. 4, illustrated is an exemplary primer deposition process being performed on a NED device housing 400 that has been formed and machined as described in relation to FIG. 3. As illustrated, the NED device housing 400 includes a polymer housing shell 401 having one or more inner surfaces 402 and one or more outer surfaces 404. The one or more inner surfaces 402 may be defined by an outer profile of a shell mold core whereas the one or more outer surfaces 404 may be defined by an inner profile of a housing shell mold cavity. In some embodiments, the NED device housing 400 may further include one or more interior apertures 406. In the specific but non-limiting embodiment, the NED device housing 400 includes four interior apertures that are labeled 406(1) through 406(4). As further illustrated, the NED device housing 400 has an outer profile 408 that may be precisely machined via one or more CNC programs.

In an exemplary embodiment, the NED device housing 400 is a CFRP material that provides benefits of being both lightweight and having a suitable rigidity and stiffness. It will be appreciated, however, that the outer perimeter of a CFRP part typically has fibrous strands 410 protruding slightly therefrom. It will be appreciated that such fibrous strands 410 may frequently protrude slightly from the outer profile of a fiber-reinforced material such as, for example, the CFRP fabric described herein. It will further be appreciated that these protrusions may increase the probability of delamination and may also cause injury if grabbed by a user. For this reason, it may be desirable to convert the sharp and fibrous outer perimeter of a CFRP housing shell into a smooth and rounded perimeter via overmolding a thermoplastic material onto the NED device housing 400.

As shown in FIG. 4, a spray tool 204 is being used to deposit a primer layer 202 a selected portion of the one or more inner surfaces 402 of the NED device housing 400 that is made from the CFRP fabric as described above. The selected region is defined in FIG. 4 as the grey region that surrounds that first aperture 406(1) and the fourth aperture 406(4). After being sprayed onto the selected portion of the NED device housing 400, the primer solution is then caused to dry (e.g., via solvent evaporation) so as to form the “dry” primer layer 202. As a specific but nonlimiting example, the NED device housing 400 with the recently sprayed “wet” primer may be baked at a temperature of 80° Celsius for at least 20 minutes.

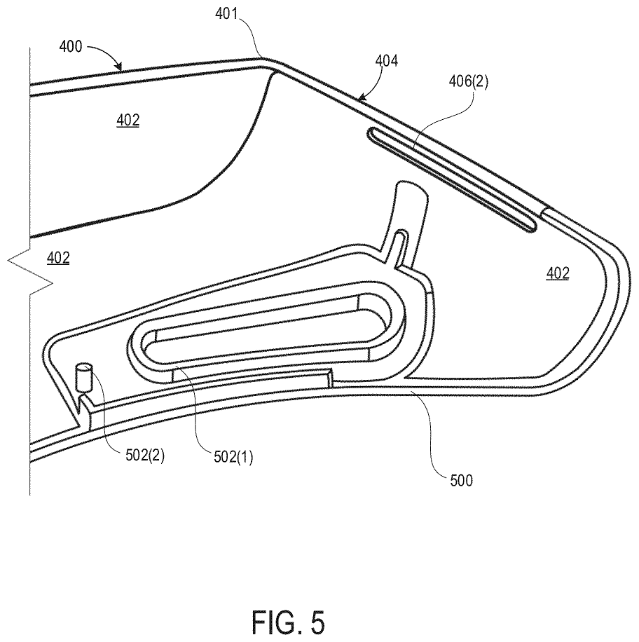

Turning now to FIG. 5, illustrated is a detailed view of the NED device housing 400 with seamlessly integrated with an overmolded thermoplastic structure 500. In the illustrated embodiment, the overmolded thermoplastic structure 500 is shown to cover the selected portion of the inner surface 402 that were illustrated as being primed in FIG. 4. The overmolded thermoplastic structure 500 is molded directly over the top of the primer layer 202 that shown as being sprayed on in FIG. 4. Thus, the overmolded thermoplastic structure 500 is adhered directly to the primer layer 202 and/or the polymer of the NED device housing 400 without any additional adhesive layer(s) between the primer layer and the thermoplastic material.

In the illustrated embodiment, the fibrous strands 410 that were shown in FIG. 4 as protruding from the outer perimeter of the NED device housing 400 are covered by the overmolded thermoplastic structure 500. In this way, the “rough” perimeter of the NED device housing 400 that would otherwise have fibers protruding therefrom and be susceptible to delamination has been converted to a smooth and rounded edge prevents delamination and is smooth to the touch when grabbed by a user.

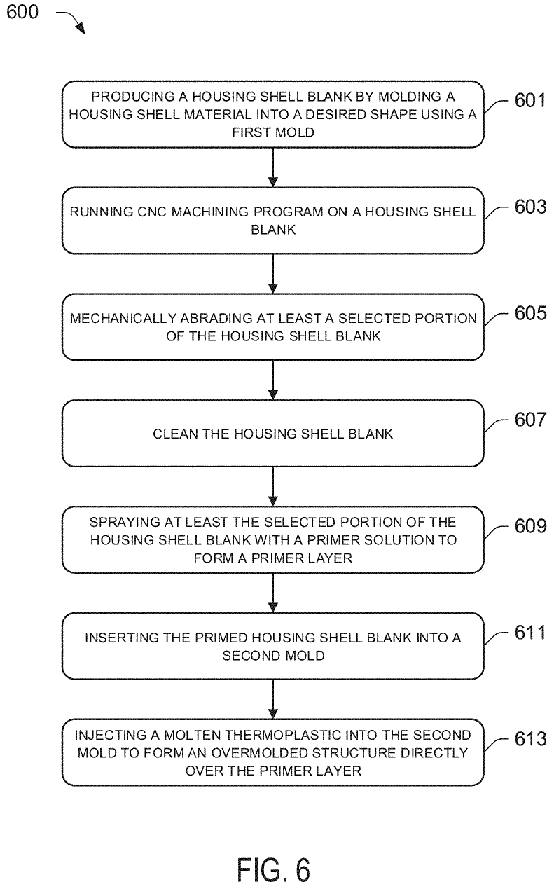

Turning now to FIG. 6, a flow chart shows an exemplary process 600 for forming a fiber-reinforced polymer housing with a thermoplastic structure that is overmolded directly over a primer layer.

At block 601, a housing shell material is molded into a desired shape using a first mold. In some embodiments, the housing shell material may be a fiber-reinforced polymer. As a specific example, the housing shell material may be a thermosetting epoxy resin impregnated carbon fiber-reinforced polymer (CFRP) fabric. In this specific example, the housing shell material may be molded into the desired shape by thermal compression molding as described in relation to FIG. 3 to form a housing shell blank. In particular, the “housing shell blank” is the raw (e.g., unmachined, unfinished, etc.) product that is removed from the first mold.

At block 603, one or more CNC programs are performed on the housing shell blank. For example, the CNC program(s) may be performed to cut or drill various features such as, for example, the apertures 406 described in relation to FIGS. 4 and 5. It will be appreciated that the performing the CNC programs may be used to achieve tighter geometrical tolerances for a perimeter than are obtainable via molding alone (e.g., to provide a precise outer profile).

At block 605, the housing shell blank may be mechanically abraded at one or more selected regions. For example, the machined housing shell blank may be sandblasted with a suitable abrasive media. As another example, the housing shell blank may be roughened with a sandpaper of a suitable grit.

At block 607, the abraded housing shell blank may be cleaned to remove any residues (e.g., machining oils and/or lubricants) or loose materials resulting from the abrasion processes at block 607. An exemplary cleaning process may include thoroughly wiping the abraded housing shell blank with a rag that is soaked in pure isopropyl alcohol. Another cleaning process may include spraying the abraded housing shell blank with stream of pressurized cleaning fluid.

At block 609, the one or more selected regions of the housing shell blank are sprayed with a suitable primer solution. In an exemplary embodiment, the primer solution is a solvent-based polyolefin primer that is thinned with an amount of solvent so as to reduce the viscosity of the solution to less than one-hundred centipoise (CPS). The primer that is deposited onto the selected regions of the housing shell blank is then cured or dried as appropriate.

At block 611, the primed housing shell blank is inserted into a second mold that is configured to overmold thermoplastic over the housing shell blank. For example, the primed housing shell blank may be inserted into a mold that has an internal cavity that is shaped to form the overmolded thermoplastic structure 500 shown in FIG. 5.

At block 613, a molten thermoplastic is injected into the second mold to form an overmolded structure directly over the primer deposited at block 609—without any additional adhesive layer(s) between the primer layer deposited at block 609 and the thermoplastic material injected at block 613. Then, the thermoplastic is allowed to cool and solidify to form a finished part.

In some embodiments, the primer layer comprises a polyolefin material and the thermoplastic material that is injected over the primer layer is a polycarbonate resin material. Thus, the polycarbonate resin material may be injected into direct contact with the polyolefin material under sufficient pressure to cause strong adhesion between the polyolefin primer layer and the polycarbonate resin material.

It should be appreciated any reference to “first,” “second,” etc. items and/or abstract concepts within the description is not intended to and should not be construed to necessarily correspond to any reference of “first,” “second,” etc. elements of the claims. In particular, within this Detailed Description and/or the previous Summary, items and/or abstract concepts such as, for example, selected regions and/or apertures may be distinguished by numerical designations without such designations corresponding to the claims or even other paragraphs of the Summary and/or Detailed Description. For example, any designation of a “first aperture” and “second aperture” within a paragraph of this disclosure is used solely to distinguish two different apertures within that specific paragraph—not any other paragraph and particularly not the claims.

FIGS. 1A-6 illustrate/describe various alternate embodiments of NED device housings that are made from a CFRP fabric base material and that have thermoplastic structures overmolded directly over a primer layer—without any additional adhesives therebetween. Specific details being illustrated/described with another specific detail or, alternatively, apart from another specific detail is not intended to be construed as a limitation. Thus, any individual detail illustrated in and/or described with respect to any figure herein may be combined in practically any manner with any other individual detail illustrated in and/or described with respect to any other figure herein. Other individual details illustrated and/or described throughout this disclosure shall be interpreted accordingly.

### EXAMPLE CLAUSES

The disclosure presented herein may be considered in view of the following clauses.

Example Clause A, a method for molding thermoplastic structures, the method comprising: forming a fiber-reinforced housing shell by molding a fiber-reinforced polymer material into a predetermined shape that is defined by a first profile of a first mold; spraying a polyolefin primer solution directly onto at least a selected portion of the fiber-reinforced polymer material that forms the fiber-reinforced housing shell, wherein the polyolefin primer solution dries to form a primer layer that is in direct contact with the fiber-reinforced polymer material; inserting the fiber-reinforced housing shell into a second mold that defines a second profile; and injecting a thermoplastic material into the second mold directly over the primer layer that is in direct contact with the fiber-reinforced polymer material.

Example Clause B, the method of Example Clause A, wherein the fiber-reinforced polymer material is a thermosetting epoxy resin impregnated carbon fiber-reinforced polymer fabric.

Example Clause C, the method of any one of Example Clauses A through B, further comprising initiating one or more computer numerical control (CNC) programs to cause a CNC machine to cut an aperture into the fiber-reinforced housing shell, wherein the spraying the polyolefin primer solution directly onto at least the selected portion includes spraying the polyolefin primer solution over the aperture.

Example Clause D, the method of any one of Example Clauses A through C, wherein the thermoplastic material is injected into the aperture.

Example Clause E, the method of any one of Example Clauses A through D, further comprising mechanically abrading the selected portion of the fiber-reinforced polymer material subsequent to the initiating the one or more CNC programs and prior to the spraying the polyolefin primer solution directly onto the selected portion of the fiber-reinforced polymer material.

Example Clause F, the method of any one of Example Clauses A through E, wherein the thermoplastic material is injected into direct contact with a plurality of fibrous strands that protrude from a perimeter of the fiber-reinforced housing shell.

Example Clause G, the method of any one of Example Clauses A through F, wherein the fiber-reinforced housing shell is a Near-Eye-Display device housing shell.

Example Clause H, the method of any one of Example Clauses A through G, wherein the polyolefin primer solution has a viscosity that is less than one-hundred centipoise.

Example Clause I, a Near-Eye-Display (NED) device housing, comprising: a polymer housing shell having one or more inner surfaces and an outer perimeter; a primer layer that is directly adhered to the polymer housing shell, wherein the primer layer is formed by spraying a primer solution directly onto a selected portion of the polymer housing shell; and an overmolded thermoplastic structure that is directly adhered to the primer layer at the selected portion of the polymer housing shell, wherein the overmolded thermoplastic structure is formed by injecting a thermoplastic material into a mold directly over the primer layer that is directly adhered to the polymer housing shell.

Example Clause J, the NED device housing of Example Clause I, wherein the polymer housing shell is formed by thermal compression molding a thermosetting epoxy resin impregnated carbon fiber-reinforced polymer fabric.

Example Clause K, the NED device housing of any one of Example Clauses I through J, wherein the primer solution is a solvent-based polyolefin primer that is sprayed directly over the thermosetting epoxy resin impregnated carbon fiber-reinforced polymer fabric.

Example Clause L, the NED device housing of any one of Example Clauses I through K, wherein the primer solution is a solvent-based polyolefin primer that has a viscosity that is less than one-hundred centipoise.

Example Clause M, the NED device housing of any one of Example Clauses I through L, further comprising an aperture that extends from the one or more inner surfaces to one or more outer surfaces of the polymer housing shell, wherein the selected portion of the polymer housing shell includes at least the aperture.

Example Clause N, the NED device housing of any one of Example Clauses I through M, wherein the polymer housing is formed by: molding a polymer material over a plurality of fibrous strands, and causing a computer numerical control (CNC) machine to cut the outer perimeter into the polymer material and the plurality of fibrous strands.

Example Clause O, the NED device housing of any one of Example Clauses A through N, wherein the thermoplastic material is injected into direct contact with the plurality of fibrous strands along the outer perimeter.

Example Clause P, a device housing, comprising: a carbon-fiber reinforced polymer housing shell having an aperture that extends from an inner surface to an outer surface; a primer layer that is directly adhered to the carbon-fiber reinforced polymer housing shell at a portion of the inner surface that surrounds the aperture; and an overmolded thermoplastic structure that is directly adhered to the primer layer at the portion of the inner surface that surrounds the aperture.

Example Clause Q, the device housing of any one of Example Clauses P through P, wherein the carbon-fiber reinforced polymer housing shell is formed by thermal compression molding a thermosetting epoxy resin impregnated carbon fiber-reinforced polymer fabric in a first mold, and wherein the overmolded thermoplastic structure is formed by injection molding a thermoplastic material directly over the primer layer in a second mold that is different than the first mold.

Example Clause R, the device housing of any one of Example Clauses P through Q, wherein the primer layer is formed by a solvent-based polyolefin primer that is sprayed directly over the thermosetting epoxy resin impregnated carbon fiber-reinforced polymer fabric.

Example Clause S, the device housing of any one of Example Clauses P through R, wherein the solvent-based polyolefin primer has a viscosity that is less than one-hundred centipoise.

Example Clause T, the device housing of any one of Example Clauses P through S, wherein the carbon-fiber reinforced polymer housing shell having the aperture that extends from the inner surface to the outer surface is a Near-Eye-Display device housing shell.

### CONCLUSION

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method for molding thermoplastic structures, the method comprising:
forming a fiber-reinforced housing shell by molding a fiber-reinforced polymer material into a predetermined shape that is defined by a first profile of a first mold;
spraying a polyolefin primer solution directly onto at least a selected portion of the fiber-reinforced polymer material that forms the fiber-reinforced housing shell, wherein the polyolefin primer solution dries to form a primer layer that is in direct contact with the fiber-reinforced polymer material;
inserting the fiber-reinforced housing shell into a second mold that defines a second profile; and
injecting a thermoplastic material into the second mold directly over the primer layer that is in direct contact with the fiber-reinforced polymer material.

2. The method of claim 1, wherein the fiber-reinforced polymer material is a thermosetting epoxy resin impregnated carbon fiber-reinforced polymer fabric.

3. The method of claim 1, further comprising initiating one or more computer numerical control (CNC) programs to cause a CNC machine to cut an aperture into the fiber-reinforced housing shell, wherein the spraying the polyolefin primer solution directly onto at least the selected portion includes spraying the polyolefin primer solution over the aperture.

4. The method of claim 3, wherein the thermoplastic material is injected into the aperture.

5. The method of claim 3, further comprising mechanically abrading the selected portion of the fiber-reinforced polymer material subsequent to the initiating the one or more CNC programs and prior to the spraying the polyolefin primer solution directly onto the selected portion of the fiber-reinforced polymer material.

6. The method of claim 1, wherein the thermoplastic material is injected into direct contact with a plurality of fibrous strands that protrude from a perimeter of the fiber-reinforced housing shell.

7. The method of claim 1, wherein the fiber-reinforced housing shell is a Near-Eye-Display device housing shell.

8. The method of claim 1, wherein the polyolefin primer solution has a viscosity that is less than one-hundred centipoise.

9. A Near-Eye-Display (NED) device housing, comprising:
a polymer housing shell having one or more inner surfaces and an outer perimeter;
a primer layer that is directly adhered to the polymer housing shell, wherein the primer layer is formed by spraying a primer solution directly onto a selected portion of the polymer housing shell; and
an overmolded thermoplastic structure that is directly adhered to the primer layer at the selected portion of the polymer housing shell, wherein the overmolded thermoplastic structure is formed by injecting a thermoplastic material into a mold directly over the primer layer that is directly adhered to the polymer housing shell.

10. The NED device housing of claim 9, wherein the polymer housing shell is formed by thermal compression molding a thermosetting epoxy resin impregnated carbon fiber-reinforced polymer fabric.

11. The NED device housing of claim 10, wherein the primer solution is a solvent-based polyolefin primer that is sprayed directly over the thermosetting epoxy resin impregnated carbon fiber-reinforced polymer fabric.

12. The NED device housing of claim 9, wherein the primer solution is a solvent-based polyolefin primer that has a viscosity that is less than one-hundred centipoise.

13. The NED device housing of claim 9, further comprising an aperture that extends from the one or more inner surfaces to one or more outer surfaces of the polymer housing shell, wherein the selected portion of the polymer housing shell includes at least the aperture.

14. The NED device housing of claim 9, wherein the polymer housing is formed by:
molding a polymer material over a plurality of fibrous strands, and
causing a computer numerical control (CNC) machine to cut the outer perimeter into the polymer material and the plurality of fibrous strands.

15. The NED device housing of claim 14, wherein the thermoplastic material is injected into direct contact with the plurality of fibrous strands along the outer perimeter.

16. A device housing, comprising:
a carbon-fiber reinforced polymer housing shell having an aperture that extends from an inner surface to an outer surface;
a primer layer that is directly adhered to the carbon-fiber reinforced polymer housing shell at a portion of the inner surface that surrounds the aperture; and
an overmolded thermoplastic structure that is directly adhered to the primer layer at the portion of the inner surface that surrounds the aperture.

17. The device housing of claim 16, wherein the carbon-fiber reinforced polymer housing shell is formed by thermal compression molding a thermosetting epoxy resin impregnated carbon fiber-reinforced polymer fabric in a first mold, and wherein the overmolded thermoplastic structure is formed by injection molding a thermoplastic material directly over the primer layer in a second mold that is different than the first mold.

18. The device housing of claim 16, wherein the primer layer is formed by a solvent-based polyolefin primer that is sprayed directly over the thermosetting epoxy resin impregnated carbon fiber-reinforced polymer fabric.

19. The device housing of claim 18, wherein the solvent-based polyolefin primer has a viscosity that is less than one-hundred centipoise.

20. The device housing of claim 16, wherein the carbon-fiber reinforced polymer housing shell having the aperture that extends from the inner surface to the outer surface is a Near-Eye-Display device housing shell.
